(19) United States
(12) Patent Application Publication
(10) Pub. No.: US 2005/0154889 A1
(43) Pub. Date: Jul. 14, 2005

(54) Method and system for a flexible lightweight public-key-based mechanism for the GSS protocol

(75) Inventors: Paul Anthony Ashley, Bardon (AU); Robert Andrew Fyfe, Broadbeach (AU); Michael James Thomas, Bonogin (AU)

Correspondence Address: IBM CORP (JRB);C/O LAW OFFICE OF JOSEPH R BURWELL, P O BOX 28022, AUSTIN, TX, 78755-8022, US

(73) Assignee: INTERNATIONAL BUSINESS MACHINES CORPORATION, ARMONK, NY (US)

(21) Appl. No.: 10/753,842

(22) Filed: Jan. 8, 2004

(51) Int. Cl. H04L 9/00

(52) U.S. Cl. 713/171; 713/156

(57) ABSTRACT

A method for establishing a secure context for communicating messages between a client and a server is presented that is compliant with the Generic Security Service application programming interface (GSS-API). The client sends to the server a first message containing a first symmetric secret key generated by the client and an authentication token; the first message is secured with the public key from the server's public key certificate. After the server authenticates the client based on the authentication token, the client then receives from the server a second message that has been secured with the first symmetric secret key and that contains a second symmetric secret key. The client and the server employ the second symmetric secret key to secure subsequent messages sent between the client and the server. The authentication token may be a public key certificate associated with the client, a username-password pair, or a secure ticket.

### BACKGROUND OF THE INVENTION

1. Field of the Invention

The present invention relates to an improved data processing system and, in particular, to a method and apparatus for multicomputer data transferring. Still more particularly, the present invention provides a method and apparatus for multicomputer communication using cryptography.

2. Description of Related Art

E-commerce web sites and other types of applications perform transactions over computer networks on behalf of users and clients. Prior to performing a requested operation on behalf of a client, the client must often pass through an authentication procedure in order to prove the client's identity to an appropriate level of certainty for security purposes.

Many data processing systems support client authentication operations through the Generic Security Service application programming interface (GSS-API), which is described in Linn, “Generic Security Services Application Program Interface”, Internet Engineering Task Force (IETF) Request for Comments (RFC) 1508, September 1993, obsoleted by Linn, “Generic Security Services Application Program Interface, Version 2”, IETF RFC 2078, January 1997. As described in those documents, GSS-API provides security services to callers in a generic fashion. GSS-API supports a range of underlying mechanisms and technologies through defined services and primitives, thereby allowing source-level portability of applications to different operational and programming language environments.

Alternate existing GSS-API mechanisms are presented in Adams, “The Simple Public-Key GSS-API Mechanism (SPKM)”, IETF RFC 2025, October 1996, and Eisler, “LIPKEY—A Low Infrastructure Public Key Mechanism Using SPKM”, IETF RFC 2847, June 2000. As described in those documents, SPKM provides authentication, key establishment, data integrity, and data confidentiality in an on-line distributed application environment using a public-key infrastructure. By conforming to GSS-API, SPKM can be used by any application that uses GSS-API calls for accessing security services. Alternatively, LIPKEY also provides a method for supplying a secure channel between a client and a server. LIPKEY is somewhat analogous to the common low infrastructure usage of the Transport Layer Security (TLS), which is an alternative method to GSS-API for implementing security functions like authentication, data integrity, and data privacy; TLS is described in Dierks et al., “The TLS Protocol, Version 1.0”, IETF RFC 2246, January 1999. LIPKEY leverages SPKM as a separate GSS-API mechanism layered above SPKM.

Given the computational demands of busy server systems, there is a need for flexible and lightweight security operations. Therefore, it would be advantageous to have a GSS-API-compliant mechanism that handles a number of forms of client authentication.

### SUMMARY OF THE INVENTION

A method, a data processing system, an apparatus, and a computer program product for establishing a secure context for communicating messages between a client and a server is presented that is compliant with the Generic Security Service application programming interface (GSS-API). The client sends to the server a first message containing a first symmetric secret key generated by the client and an authentication token; the first message is secured with the public key from a public key certificate associated with the server. Assuming that the server is able to authenticate the client based on the authentication token, the client then receives from the server a second message that has been secured with the first symmetric secret key and that contains a second symmetric secret key. The client and the server employ the second symmetric secret key to secure subsequent messages sent between the client and the server. The authentication token may be a public key certificate associated with the client, a username-password pair, or a secure ticket.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical network of data processing systems, each of which may implement the present invention;

FIG. 1B depicts a typical computer architecture that may be used within a data processing system in which the present invention may be implemented;

FIG. 2 depicts a block diagram that shows a typical manner in which an individual obtains a digital certificate;

FIG. 3 depicts a block diagram that shows a typical manner in which an entity may use a digital certificate to be authenticated to a data processing system;

FIG. 4 depicts a data flow diagram that shows a typical GSS-API-compliant mechanism for establishing a secure communication context between a client and a server; and

FIG. 5 depicts a data flow diagram that shows a typical GSS-API-compliant mechanism for establishing a secure communication context between a client and a server in accordance with an embodiment of the present invention.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

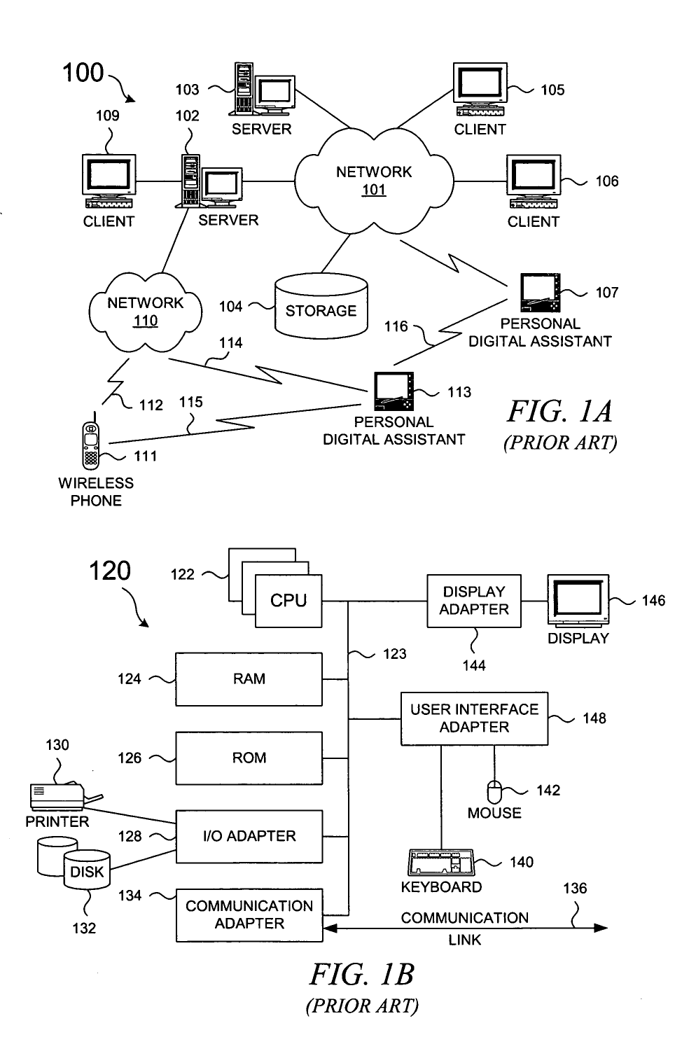

With reference now to the figures, FIG. 1A depicts a typical network of data processing systems, each of which may implement a portion of the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as an audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The descriptions of the figures herein involve certain actions by either a client device or a user of the client device. One of ordinary skill in the art would understand that responses and/or requests to/from the client are sometimes initiated by a user and at other times are initiated automatically by a client, often on behalf of a user of the client. Hence, when a client or a user of a client is mentioned in the description of the figures, it should be understood that the terms “client” and “user” can be used interchangeably without significantly affecting the meaning of the described processes.

The present invention may be implemented on a variety of hardware and software platforms, as described above with respect to FIG. 1A and FIG. 1B. More specifically, though, the present invention is directed to an improved public-key-based mechanism for establishing a secure context for communication between a client and a server that is compliant with the Generic Security Services Application Program Interface (GSS-API); a secure context comprises information that is shared between two or more communicating entities for the duration of a communication session during which multiple secure messages may be exchanged between the communicating entities. Before describing the present invention in more detail, though, some background information about digital certificates is provided for evaluating the operational efficiencies and other advantages of the present invention.

Digital certificates support public key cryptography in which each party involved in a communication or transaction has a pair of keys, called the public key and the private key. Each party's public key is published while the private key is kept secret. Public keys are numbers associated with a particular entity and are intended to be known to everyone who needs to have trusted interactions with that entity. Private keys are numbers that are supposed to be known only to a particular entity, i.e. kept secret. In a typical asymmetric cryptographic system, a private key corresponds to exactly one public key.

Within a public key cryptography system, since all communications involve only public keys and no private key is ever transmitted or shared, confidential messages can be generated using only public information and can be decrypted using only a private key that is in the sole possession of the intended recipient. Furthermore, public key cryptography can be used for authentication, i.e. digital signatures, as well as for privacy, i.e. encryption.

Encryption is the transformation of data into a form unreadable by anyone without a secret decryption key; encryption ensures privacy by keeping the content of the information hidden from anyone for whom it is not intended, even those who can see the encrypted data. Authentication is a process whereby the receiver of a digital message can be confident of the identity of the sender and/or the integrity of the message.

For example, when a sender encrypts a message, the public key of the receiver is used to transform the data within the original message into the contents of the encrypted message. A sender uses a public key of the intended recipient to encrypt data, and the receiver uses its private key to decrypt the encrypted message.

When authenticating data, data can be signed by computing a digital signature from the data using the private key of the signer. Once the data is digitally signed, it can be stored with the identity of the signer and the signature that proves that the data originated from the signer. A signer uses its private key to sign data, and a receiver uses the public key of the signer to verify the signature.

A certificate is a digital document that vouches for the identity and key ownership of entities, such as an individual, a computer system, a specific server running on that system, etc. Certificates are issued by certificate authorities. A certificate authority (CA) is an entity, usually a trusted third party to a transaction, that is trusted to sign or issue certificates for other people or entities. The CA usually has some kind of legal responsibilities for its vouching of the binding between a public key and its owner that allow one to trust the entity that signed a certificate. There are many commercial certificate authorities; these authorities are responsible for verifying the identity and key ownership of an entity when issuing the certificate.

If a certificate authority issues a certificate for an entity, the entity must provide a public key and some information about the entity. A software tool, such as specially equipped Web browsers, may digitally sign this information and send it to the certificate authority. The certificate authority might be a commercial company that provides trusted third-party certificate authority services. The certificate authority will then generate the certificate and return it. The certificate may contain other information, such as a serial number and dates during which the certificate is valid. One part of the value provided by a certificate authority is to serve as a neutral and trusted introduction service, based in part on their verification requirements, which are openly published in their Certification Service Practices (CSP).

A CA creates a new digital certificate by embedding the requesting entity's public key along with other identifying information and then signing the digital certificate with the CA's private key. Anyone who receives the digital certificate during a transaction or communication can then use the public key of the CA to verify the signed public key within the certificate. The intention is that the CA's signature acts as a tamper-proof seal on the digital certificate, thereby assuring the integrity of the data in the certificate.

Other aspects of certificate processing are also standardized. The Certificate Request Message Format (RFC 2511) specifies a format that has been recommended for use whenever a relying party is requesting a certificate from a CA. Certificate Management Protocols have also been promulgated for transferring certificates.

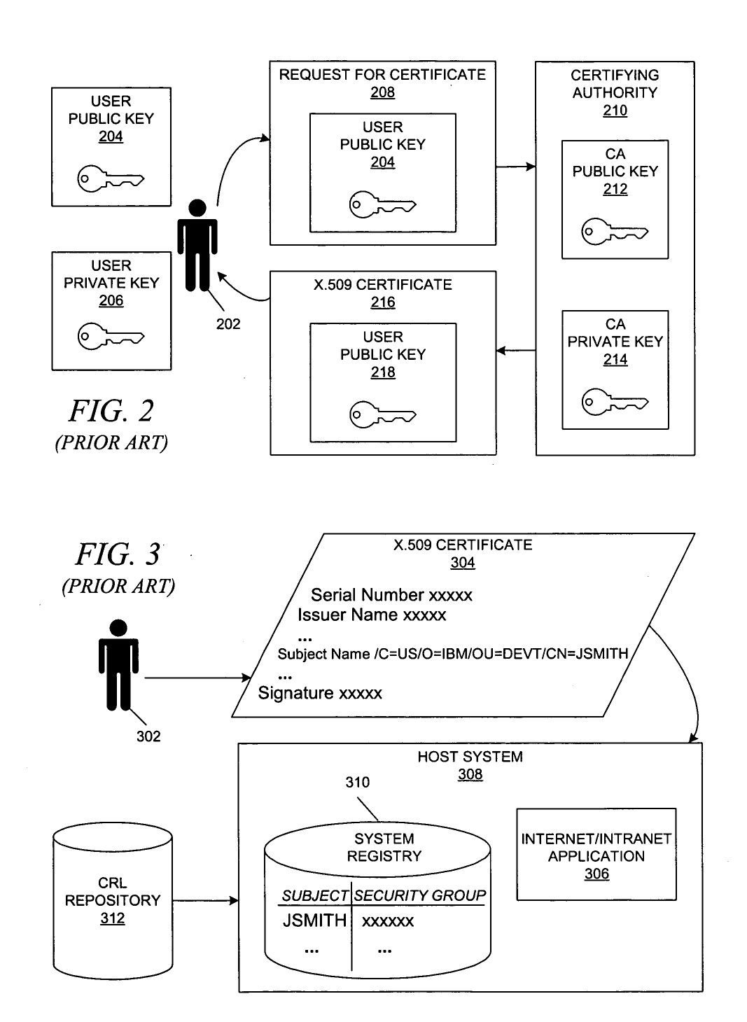

The present invention resides in a distributed data processing system that employs digital certificates; the description of FIGS. 2-3 provides background information about typical operations involving digital certificates.

With reference now to FIG. 2, a block diagram depicts a typical manner in which an individual obtains a digital certificate. User 202, operating on some type of client computer, has previously obtained or generated a public/private key pair, e.g., user public key 204 and user private key 206. User 202 generates a request for certificate 208 containing user public key 204 and sends the request to certifying authority 210, which is in possession of CA public key 212 and CA private key 214. Certifying authority 210 verifies the identity of user 202 in some manner and generates X.509 digital certificate 216 containing user public key 218. The entire certificate is signed with CA private key 214; the certificate includes the public key of the user, the name associated with the user, and other attributes. User 202 receives newly generated digital certificate 216, and user 202 may then present digital certificate 216 as necessary to engage in trusted transactions or trusted communications. An entity that receives digital certificate 216 from user 202 may verify the signature of the CA by using CA public key 212, which is published and available to the verifying entity.

With reference now to FIG. 3, a block diagram depicts a typical manner in which an entity may use a digital certificate to be authenticated to a data processing system. User 302 possesses X.509 digital certificate 304, which is transmitted to an Internet or intranet application 306 on host system 308; application 306 comprises X.509 functionality for processing and using digital certificates. User 302 signs or encrypts data that it sends to application 306 with its private key.

The entity that receives certificate 304 may be an application, a system, a subsystem, etc. Certificate 304 contains a subject name or subject identifier that identifies user 302 to application 306, which may perform some type of service for user 302. The entity that uses certificate 304 verifies the authenticity of the certificate before using the certificate with respect to the signed or encrypted data from user 302.

Host system 308 may also contain system registry 310 which is used to authorize user 302 for accessing services and resources within system 308, i.e. to reconcile a user's identity with user privileges. For example, a system administrator may have configured a user's identity to belong to certain a security group, and the user is restricted to being able to access only those resources that are configured to be available to the security group as a whole. Various well-known methods for imposing an authorization scheme may be employed within the system.

In order to properly validate or verify a digital certificate, an application must check whether the certificate has been revoked. When the certifying authority issues the certificate, the certifying authority generates a unique serial number by which the certificate is to be identified, and this serial number is stored within the “Serial Number” field within an X.509 certificate. Typically, a revoked X.509 certificate is identified within a CRL via the certificate's serial number; a revoked certificate's serial number appears within a list of serial numbers within the CRL.

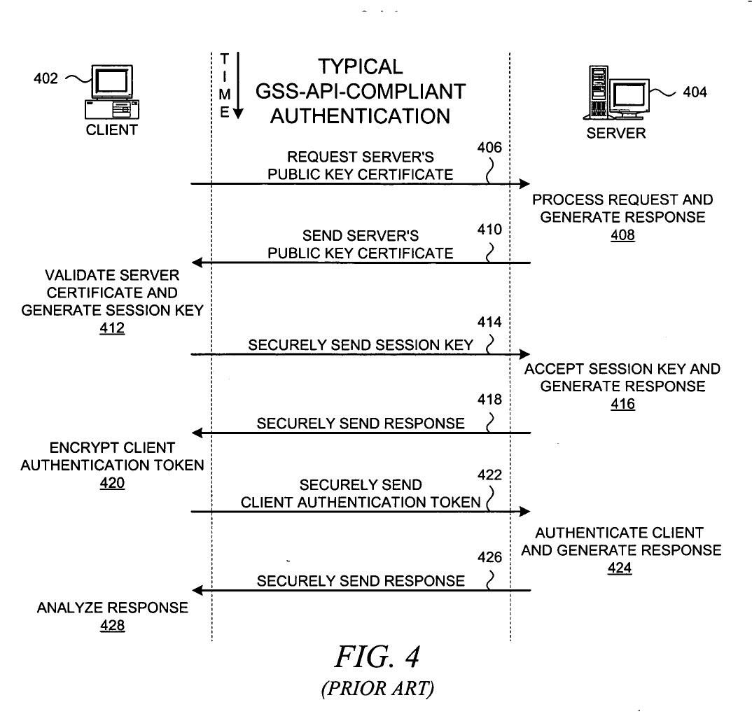

In order to determine whether certificate 304 is still valid, application 306 obtains a certificate revocation list (CRL) from CRL repository 312 and validates the CRL. Application 306 compares the serial number within certificate 304 with the list of serial numbers within the retrieved CRL, and if there are no matching serial numbers, then application 306 validates certificate 304. If the CRL has a matching serial number, then certificate 304 should be rejected, and application 306 can take appropriate measures to reject the user's request for access to any controlled resources.

Whereas FIG. 3 illustrates a generic method for a client to employ a digital certificate for accessing a server, FIG. 4 illustrates details of the transfer of information between the client and the server for establishing a secure communication context, which was not described with respect to FIG. 3.

With reference now to FIG. 4, a data flow diagram depicts a typical GSS-API-compliant mechanism for establishing a secure communication context between a client and a server. The process commences with client 402 sending a request to server 404 for the server's public key certificate (step 406). The server processes the request and generates a response (step 408) that contains or accompanies a copy of the server's public key certificate that is returned to the requesting client (step 410).

The client validates the server's public key certificate and generates a session key (step 412); the session key is preferably a symmetric secret key. The client then securely sends the session key to the server (step 414). For example, the client may encrypt the session key with the server's public key that has been previously extracted from the server's public key certificate. The encrypted session key is then placed into a message that is digitally signed with the client's private key. The server is able to verify the digital signature on the message with the client's public key to ensure that the message has been created and signed by the client, and the session key may be decrypted only by the server. For a description of applicable formats for digital envelopes and digital signatures, see “PKCS #7: Cryptographic Message Syntax Standard”, Version 1.5, RSA Laboratories Technical Note, Nov. 1, 1993.

The server subsequently accepts the session key, e.g., after verifying the client's digital signature and decrypting the session key, and then generates a secure response (step 416), which is returned to the client (step 418). The client then generates and encrypts a client authentication token (step 420) and securely sends the client authentication token to the server (step 422). After extracting the client authentication token from the received message, the server authenticates the client and generates a response (step 424), which is securely returned to the client (step 426). The client then analyzes the response to determine whether the client has been positively authenticated by the server or whether the server has rejected the client's authentication request (step 428), and the process is concluded.

As noted above, FIG. 4 illustrates a typical method for establishing a secure communication context in accordance with a known GSS-API-compliant mechanism. In contrast, the present invention is directed to an improved public-key-based GSS-API-compliant mechanism for establishing a secure communication context, as described hereinbelow with respect to the remaining figures.

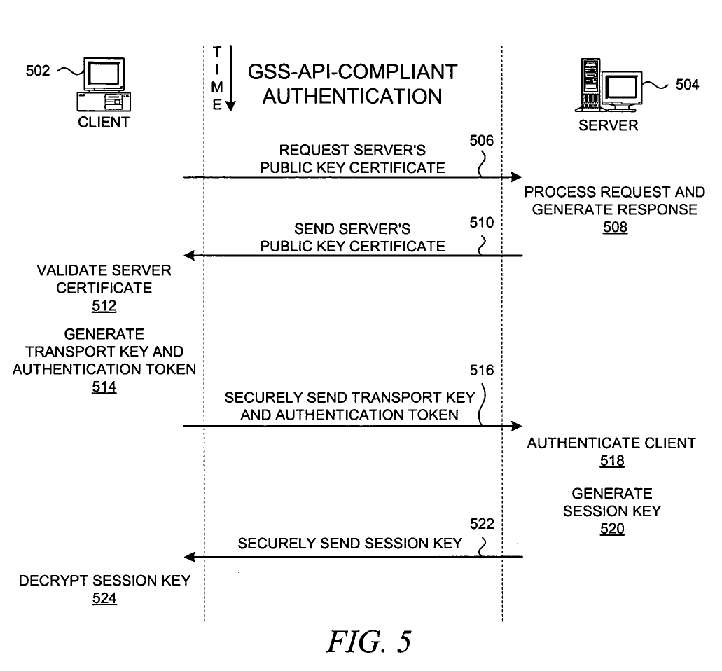

With reference now to FIG. 5, a data flow diagram depicts a typical GSS-API-compliant mechanism for establishing a secure communication context between a client and a server in accordance with an embodiment of the present invention. The process commences with client 502 sending a request to server 504 to obtain the server's public key certificate (step 506), e.g., when the client attempts to bind to the server application. Upon receiving the request, the server processes the request and generates a response (step 508) that contains or accompanies a copy of the server's public key certificate that is returned to the requesting client (step 510).

After receiving the server's digital certificate, the client validates the server's public key certificate to ensure that it has been signed by a trusted certificate authority (step 512). It should be noted that the client may recognize that it has previously validated and stored a copy of this server's public key certificate, thereby allowing the client to obtain the server's certificate by retrieving it from a local cache. Alternatively, the server's public key certificate may be provided to the client in some other manner, e.g., through retrieval of the server's public key certificate by the client from a directory or similar datastore.

Assuming that the server's certificate has been positively validated, the client extracts the server's public key from the certificate and caches it. The client then generates a random symmetric secret key along with an authentication token (step 514); this particular secret key is herein referred to as the transport key. The authentication token may comprise a username-password pair, a time-stamped secure ticket from a principal authenticator, a public key certificate associated with the client, or some other authenticatable information; the client may generate the authentication token, when appropriate, by merely copying a data item, such as a secure ticket.

The client then securely sends the transport key and the authentication token to the server (step 516). The transmission of the transport key and the authentication token from the client to the server is secured in some manner through encryption using the server's public key. For example, the transport key and the authentication token may be encrypted using the server's public key to form a digital envelope on the message that is sent to the server. Alternatively, the transport key and the authentication token may be encrypted individually for inclusion in a message to the server.

Upon receiving the secure message from the client, the server decrypts the digital envelope with the server's private key. The server then authenticates the client or the user of the client (step 518) using a process that is appropriate for the type of authentication token that has been sent to the server, i.e. based on the type of authentication token that has been sent by the client to the server. For example, the server may perform an LDAP lookup for a username-password pair or may validate a secure ticket, e.g., a Kerberos ticket. In the case in which the authentication token is a client certificate, the authentication is achieved when the server responds with a random session key encrypted by the client public key (a digital envelope) which only the true client can decrypt using the private key associated with the public key in the client certificate; the digital envelope is still sent encrypted under the transport key that the client sends to the server to prevent a man in the middle attack. Assuming that the client has been authenticated, the server then generates a random symmetric secret key (step 520) which will be used to secure messages within the communication context that is being created between the client and the server; this particular secret key is herein referred to as the session key.

The server then securely sends the session key to the client (step 522). The transmission of the session key from the server to the client is secured in some manner through encryption using the transport key. For example, the server may place the session key into a session token that the server encrypts with the transport key; the server may then place the encrypted session token into a message that the server seals with the client's public key and then encrypts the resulting envelope with the transport key. Alternatively, the server may use the transport key to encrypt the session key individually before placing the encrypted session key into a message to be sent to the client. As another example of generating a secure message, the server may use the transport key to generate a digital envelope on a message that contains the session key.

After receiving the message, the client uses the transport key to decrypt the appropriate portion of the message and to extract the session key (step 524), thereby concluding the process. Depending on the authentication mechanism that was used, the server may have generated the message in different formats; hence, the client may obtain the session key directly from a session token, or the client may need to decrypt the session key with the client's private key if the server had also used the client's public key to encrypt the session key or to encrypt a portion of the message that contains the session key. Additionally, messages between the client and the server may include a sequence number to secure against replay attacks.

After the process has been concluded, the client and the server both possess a copy of the session key that can be subsequently employed to secure messages between the client and the server, thereby securely ensuring data confidentiality and data integrity for the communication context between the client and the server. For example, the client may use the session key to securely send request messages to the server to access resources that are controlled by the server. It should be understood by one having ordinary skill in the art that the session key may be employed for a given communication session between the client and the server, that the given communication session between the client and the server may be concurrent with other secure communication sessions between the client and the server and/or other servers within secure contexts provided by the GSS-API-compliant mechanism of the present invention or within secure contexts provided by some other mechanism, and that the given communication session may be terminated while allowing those concurrent sessions to continue.

The advantages of the present invention should be apparent in view of the detailed description that is provided above. Compared with prior art GSS-API-compliant mechanisms for establishing a secure communication context, the present invention provides the ability to expand from a username-password type of client-server authentication operation to a full public-key infrastructure (PKI) solution on an as-needed basis while continuing to use the same GSS-API-compliant mechanism as the previously implemented username-password solution. In addition, the present invention allows a client to authenticate using a public key certificate, which LIPKEY does not allow. Moreover, the present invention allows a variety of client authentication mechanisms, such as username-password, secure ticket, or public key certificate, which SPKM does not support. Furthermore, the present invention minimizes network traffic and cryptographic operations in comparison to LIPKEY, e.g., four messages are exchanged between a client and a server instead of LIPKEY's six messages.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

1. A method for establishing a secure context for communicating messages between a first system and a second system, the method comprising:
obtaining by the second system a first public key certificate of the first system, wherein the second system is able to validate the first public key certificate that contains a public key;
generating by the second system a transport key, wherein the transport key is a symmetric secret key;
placing by the second system the transport key and an authentication token into a first message secured with the public key;
sending the first message from the second system to the first system;
receiving at the second system from the first system a second message secured with the transport key in response to sending the first message to the first system;
extracting by the second system a session key from the second message, wherein the session key is a symmetric secret key; and
employing the session key to secure subsequent messages sent by the second system to the first system.

2. The method of claim 1 wherein the authentication token comprises a second public key certificate of the second system, and wherein the first system is able to validate the second public key certificate.

3. The method of claim 2 further comprises:
decrypting, by the second system using a private key associated with the second public key certificate, a digital envelope in the second message containing the session key, wherein the digital envelope was created by the first system using a public key contained in the second public key certificate.

4. The method of claim 1 wherein the authentication token comprises a username-password pair.

5. The method of claim 1 wherein the authentication token comprises a secure ticket.

6. A method for establishing a secure context for communicating messages between a first system and a second system, the method comprising:
providing by the first system a public key certificate associated with the first system, wherein the second system is able to validate the public key certificate;
receiving at the first system from the second system a first message, wherein the first message is secured with a public key from the public key certificate associated with the first system, wherein the first message contains a transport key and an authentication token, and wherein the transport key is a symmetric secret key;
authenticating the second system by the first system based on the authentication token;
generating by the first system a session key, wherein the session key is a symmetric secret key;
placing by the first system the session key into a second message secured with the transport key;
sending the second message from the first system to the second system in response to receiving the first message; and
receiving at the first system from the second system subsequent messages secured with the session key.

7. The method of claim 6 wherein the authentication token comprises a public key certificate associated with the second system.

8. The method of claim 7 further comprising:
creating, by the first system using a public key contained in the public key certificate associated with the second system, a digital envelope in the second message containing the session key.

9. The method of claim 6 wherein the authentication token comprises a username-password pair.

10. The method of claim 6 wherein the authentication token comprises a secure ticket.

11. A computer program product on a computer readable medium for use in a second system for establishing a secure context for communicating messages between a first system and the second system, the computer program product comprising:
means for obtaining a public key certificate containing a public key associated with the first system;
means for generating a transport key, wherein the transport key is a symmetric secret key;
means for placing the transport key and an authentication token into a first message secured with the public key;
means for sending the first message to the first system;
means for receiving from the first system a second message secured with the transport key in response to sending the first message to the first system;
means for extracting a session key from the second message, wherein the session key is a symmetric secret key; and
means for employing the session key to secure subsequent messages sent to the first system.

12. The computer program product of claim 11 wherein the authentication token comprises a second public key certificate associated with the second system, a username-password pair, or a secure ticket.

13. A computer program product on a computer readable medium for use in a first system for establishing a secure context for communicating messages between a first system and the second system, the computer program product comprising:
means for providing a public key certificate associated with the first system;
means for receiving a first message from the second system, wherein the first message is secured with a public key from the public key certificate associated with the first system, wherein the first message contains a transport key and an authentication token, and wherein the transport key is a symmetric secret key;
means for authenticating the second system based on the authentication token;
means for generating a session key, wherein the session key is a symmetric secret key;
means for placing the session key into a second message secured with the transport key;
means for sending the second message to the second system in response to receiving the first message; and
means for receiving from the second system subsequent messages secured with the session key.

14. The computer program product of claim 13 wherein the authentication token comprises a public key certificate associated with the second system, a username-password pair, or a secure ticket.

15. An apparatus for establishing a secure context for communicating messages between a first system and a second system, the apparatus comprising:
means for obtaining a public key certificate containing a public key associated with the first system;
means for generating a transport key, wherein the transport key is a symmetric secret key;
means for placing the transport key and an authentication token into a first message secured with the public key;
means for sending the first message to the first system;
means for receiving from the first system a second message secured with the transport key in response to sending the first message to the first system;
means for extracting a session key from the second message, wherein the session key is a symmetric secret key; and
means for employing the session key to secure subsequent messages sent to the first system.

16. The apparatus of claim 15 wherein the authentication token comprises a second public key certificate associated with the second system, a username-password pair, or a secure ticket.

17. An apparatus for establishing a secure context for communicating messages between a first system and a second system, the apparatus comprising:
means for providing a public key certificate associated with the first system;
means for receiving a first message from the second system, wherein the first message is secured with a public key from the public key certificate associated with the first system, wherein the first message contains a transport key and an authentication token, and wherein the transport key is a symmetric secret key;
means for authenticating the second system based on the authentication token;
means for generating a session key, wherein the session key is a symmetric secret key;
means for placing the session key into a second message secured with the transport key;
means for sending the second message to the second system in response to receiving the first message; and
means for receiving from the second system subsequent messages secured with the session key.

18. The apparatus of claim 17 wherein the authentication token comprises a public key certificate associated with the second system, a username-password pair, or a secure ticket.
